(19) United States
(12) Patent Application Publication
(10) Pub. No.: US 2004/0094951 A1
(43) Pub. Date: May 20, 2004

(54) Conduit sealing system

(76) Inventors: Peter C. Sigrist, Bellevue, WA (US); Robert L. Studer, Fall City, WA (US)

Correspondence Address: Michael S. Neustel, Suite No. 4, 2534 South University Drive, Fargo, ND, 58103, US

(21) Appl. No.: 10/288,479

(22) Filed: Nov. 4, 2002

Related U.S. Application Data
(63) Continuation-in-part of application No. 10/207,755, now abandoned.

(51) Int. Cl. F16L 27/00

(52) U.S. Cl. 285/139.1; 285/205; 285/354

(57) ABSTRACT

A conduit sealing system for effectively sealing a conduit member within an object the conduit member passes through. The conduit sealing system includes a coupler member having a first threaded portion and a second threaded portion, a first retainer member threadably connected to the first threaded portion, a second retainer member threadably connected to the second threaded portion, and a seal member positioned within the coupler member for sealing about a conduit member or cable.

### CROSS REFERENCE TO RELATED APPLICATIONS

I hereby claim benefit under Title 35, United States Code, Section 120 of U.S. patent application Ser. No. 10/207,755 filed Jul. 30, 2002. This application is a continuation-in-part of the Ser. No. 10/207,755 application. The Ser. No. 10/207,755 application is currently pending. The Ser. No. 10/207,755 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to pipe sealing devices and more specifically it relates to a conduit sealing system for effectively sealing a conduit member within an object the conduit member passes through.

2. Description of the Related Art

Lengths of cable and conduit extend through various objects such as but not limited to walls, floors, ceilings, platforms, junction boxes, buildings, vehicles, boats, tractors, and the like. It is important to seal the exterior of the conduit within the object to prevent water, insects and other debris from passing about conduit. Conventional seals utilized today mainly consist of utilizing a liquid sealant such as but not limited to silicone and the like.

The main problem with conventional seals for cable and conduit extending through structures is that they do not have a significant useful life. A further problem with conventional seals is that they easily become worn and damaged over extended periods of time. Another problem with conventional seals is that they do not provide a uniform seal about the exterior of a cable or conduit. A further problem with conventional seals is that they do provide a tight seal against the exterior of the wire or conduit.

Examples of patented devices which may be related to the present invention include U.S. Pat. No. 6,183,021 to Walsh et al.; U.S. Pat. No. 2,537,183 to E. J. Bloomer; U.S. Pat. No. 5,433,487 to Kuhn et al.; U.S. Pat. No. 5,129,684 to Lawrence et al.; U.S. Pat. No. 2,258,941 to A. J. Wayman; U.S. Pat. No. 5,697,194 to Gignac et al.; U.S. Pat. No. 833,239 to C. F. Plunkett; U.S. Pat. No. 3,058,760 to J. T. Bankowski; U.S. Pat. No. 4,974,879 to Berch et al.; U.S. Pat. No. 1,968,368 to A. O. Bredeson; U.S. Pat. No. 6,302,449 to Clayton; U.S. Pat. No. 2,276,969 to H. H. Heinichen; U.S. Pat. No. 4,627,647 to Hauff; and U.S. Pat. No. 2,670,976 to F. M. Owen.

While these devices may be suitable for the particular purpose to which they address, they are not as suitable for effectively sealing a conduit member within an object the conduit member passes through. Conventional liquid sealants are not effective in maintaining a seal between a wire or conduit and a structure they pass through.

In these respects, the conduit sealing system according to the present invention substantially departs from the conventional concepts and designs of the prior art, and in so doing provides an apparatus primarily developed for the purpose of effectively sealing a conduit member within an object the conduit member passes through.

### BRIEF SUMMARY OF THE INVENTION

In view of the foregoing disadvantages inherent in the known types of sealing devices now present in the prior art, the present invention provides a new conduit sealing system construction wherein the same can be utilized for effectively sealing a conduit member within an object the conduit member passes through.

The general purpose of the present invention, which will be described subsequently in greater detail, is to provide a new conduit sealing system that has many of the advantages of the sealing systems mentioned heretofore and many novel features that result in a new conduit sealing system which is not anticipated, rendered obvious, suggested, or even implied by any of the prior art sealing devices, either alone or in any combination thereof.

To attain this, the present invention generally comprises a coupler member having a first threaded portion and a second threaded portion, a first retainer member threadably connected to the first threaded portion, a second retainer member threadably connected to the second threaded portion, and a seal member positioned within the coupler member for sealing about a conduit member or cable.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a conduit sealing system that will overcome the shortcomings of the prior art devices.

A second object is to provide a conduit sealing system for effectively sealing a cable member or conduit member within an object the conduit member passes through.

Another object is to provide a conduit sealing system that may be utilized with various sizes of cables and conduit.

An additional object is to provide a conduit sealing system that may be utilized within various types of structures that a cable or conduit pass through.

A further object is to provide a conduit sealing system that is attachable to structure having various thicknesses.

Another object is to provide a conduit sealing system that may be utilized in high pressure areas.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an exploded upper perspective view of the present invention.

FIG. 2 is an upper perspective view of the present invention secured about a conduit member and a wall.

FIG. 3 is a side cutaway view of the present invention secured about a conduit member and a wall.

FIG. 4 is a side view of the present invention secured about a conduit member and a wall.

### DETAILED DESCRIPTION OF THE INVENTION

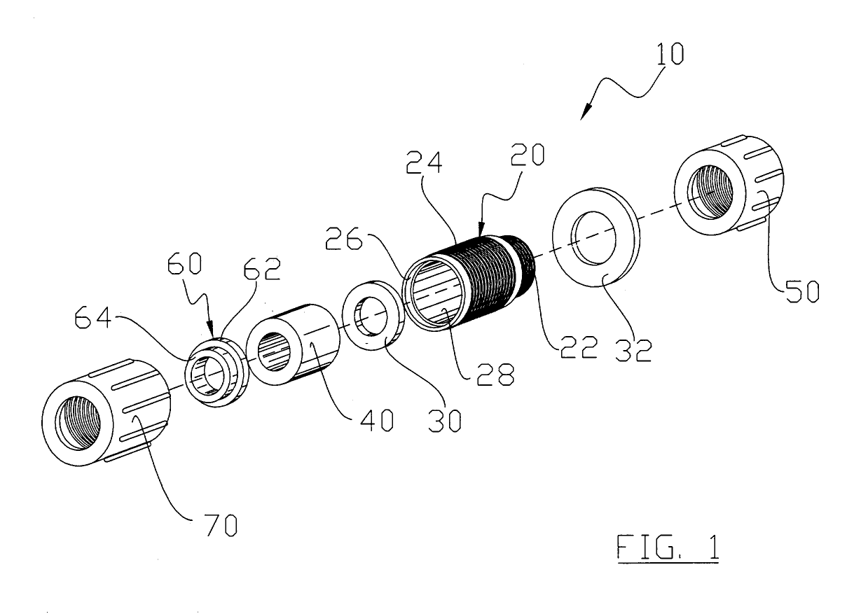

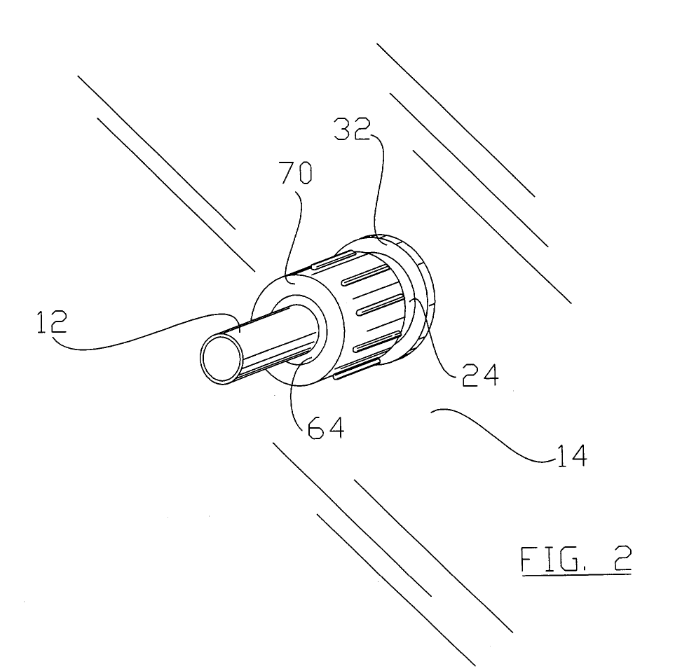

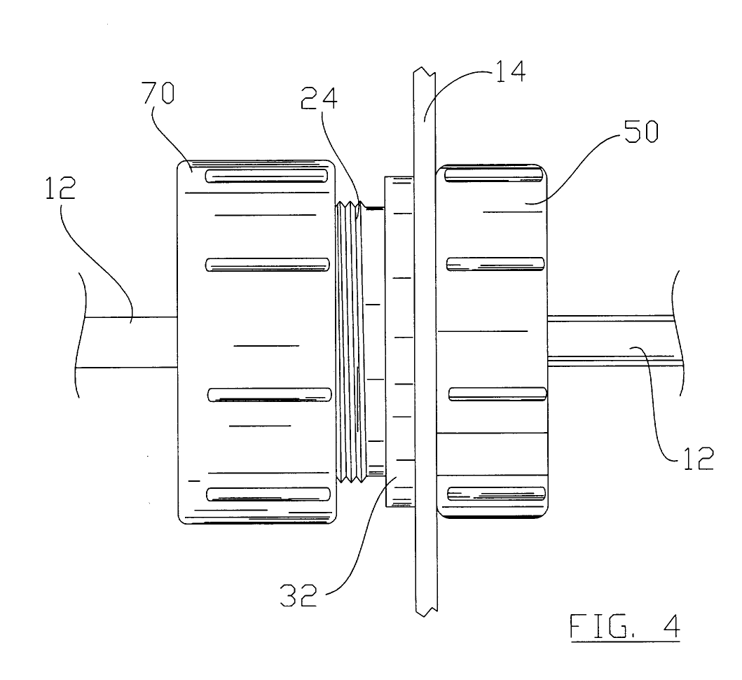

Turning now descriptively to the drawings, in which similar reference characters denote similar elements throughout the several views, FIGS. 1 through 4 illustrate a conduit sealing system 10, which comprises a coupler member 20 having a first threaded portion 22 and a second threaded portion 24, a first retainer member 50 threadably connected to the first threaded portion 22, a second retainer member 70 threadably connected to the second threaded portion 24, and a seal member 40 positioned within the coupler member 20 for sealing about a conduit member 12 or cable.

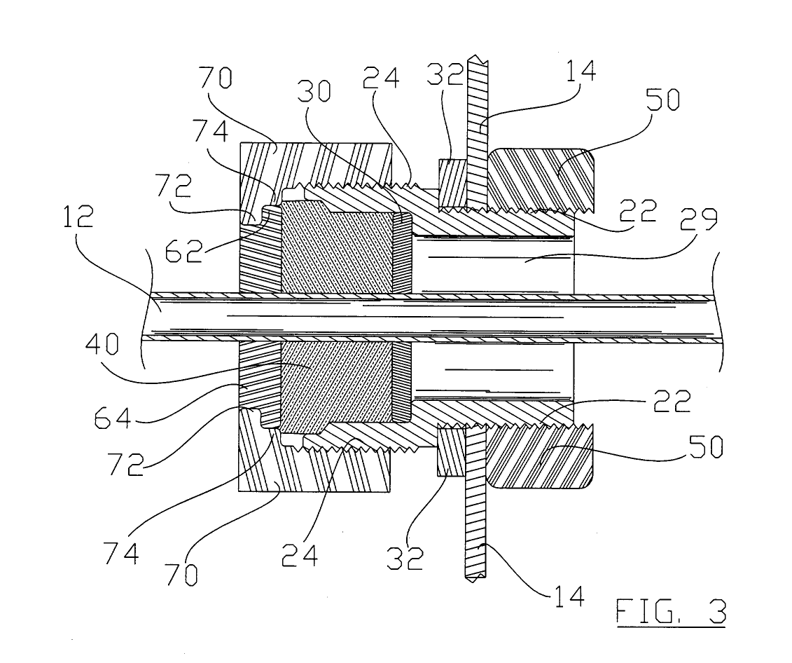

As best shown in FIGS. 1 and 3 of the drawings, the coupler member 20 is comprised of a generally tubular structure. The coupler member 20 has a first threaded portion 22 and a second threaded portion 24 on opposing portions of the coupler member 20. The first threaded portion 22 preferably has a smaller outer diameter and an inner diameter than the second threaded portion 24 as best illustrated in FIG. 3 of the drawings. The first threaded portion 22 has a length sufficient to pass through the wall 14 or other structure and allow for the first retainer member 50 to be properly secured thereto.

The second threaded portion 24 preferably includes a first lumen portion 26 near the first opening of the coupler member 20 as shown in FIG. 1 of the drawings. The first lumen portion 26 preferably is tapered inwardly after a finite distance as best illustrated in FIG. 3 of the drawings. The second threaded portion 24 also preferably includes a second lumen portion 28 connected to the first lumen portion 26 as further shown in FIG. 1 of the drawings. The second threaded portion 24 preferably has a smaller diameter than the first threaded portion 22 thereby forming an outer lip as shown in FIG. 3 of the drawings.

As shown in FIG. 3 of the drawings, the first threaded portion 22 includes a third lumen portion 29 connected to the second lumen portion 28. The third lumen portion 29 preferably has a diameter smaller than the second lumen portion 28 thereby forming an inner lip for receiving the first washer 30 as shown in FIG. 3 of the drawings.

As shown in FIGS. 1, 3 and 4 of the drawings, a first retainer member 50 is threadably attached to the first threaded portion 22. The first retainer member 50 is engagable to a first side of the wall 14 or other structure that the conduit sealing system 10 is positioned within.

As shown in FIG. 3 of the drawings, a second washer 32 is preferably positioned between the wall 14 and the outer lip of the second portion 64 of the coupler member 20. It can be appreciated that the conduit sealing system 10 may be installed within a structure such as a wall 14 without the usage of the second washer 32 if the outer lip is sufficient in size to engage the wall 14 opposite of the first retainer member 50.

As shown in FIG. 3 of the drawings, a first washer 30 is positioned within the second lumen portion 28 adjacent the inner lip. The first washer 30 has a center opening having an inner diameter approximately equal to the outer diameter of the conduit member 12 as shown in FIG. 3 of the drawings.

As shown in FIG. 3 of the drawings, the seal member 40 is positioned within the first lumen portion 26 and the second lumen portion 28 in a compressed manner thereby compressing about the exterior surface of the conduit member 12 to form a water resistant and pressure resistant seal. The seal member 40 is preferably comprised of a resilient material such as but not limited to rubber. The seal member 40 has a center aperture formed to receive the conduit member 12 in a movable manner before being compressed within the coupler member 20.

As shown in FIG. 3 of the drawings, a main washer 60 having a first portion 62 and a second portion 64 is retained against the seal member 40 by the second retainer member 70. The first portion 62 of the main washer 60 has a smaller diameter than the second portion 64 of the main washer 60. The main washer 60 has a center opening that is preferably sufficient in diameter to receive the conduit member 12 as shown in FIG. 3 of the drawings.

The second retainer member 70 is threadably attached to the second portion 64 of the coupler member 20 as shown in FIG. 3 of the drawings. The second retainer member 70 includes a first inner lip 72 that is engagable with the second portion 64 of the main washer 60. The second retainer member 70 preferably includes a second inner lip 74 that is positioned about the exterior of the second portion 64.

In use, the user positions the first threaded portion 22 of the coupler member 20 within an aperture within the wall 14 or other structure that will receive the conduit member 12. The user then secures the first retainer member 50 to the first threaded portion 22 on a first side of the wall 14 until either the second washer 32 or the outer lip of the coupler member 20 is tight against the wall 14. The user then extends the conduit member 12 or elongate object through the coupler member 20. The user then positions the seal member 40 upon the conduit member 12 and positions the seal member 40 within the first lumen portion 26 of the coupler member 20. The second retainer member 70 is then threadably attached to the second threaded portion 24 with the main washer 60 positioned within and the first washer 30 properly positioned within the coupler member 20 as illustrated in FIG. 3 of the drawings. The user then tightens the second retainer member 70 upon the seal member 40 thereby forcing the seal member 40 into the first lumen portion 26 and the second lumen portion 28. The tapered portion of the first lumen portion 26 guides and compresses the seal member 40 inwardly to the second lumen portion 28. As the seal member 40 is compressed, the seal member 40 forms a tight seal upon the conduit member 12. The second retainer member 70 is tightened upon the second threaded portion 24 until the seal member 40 is tightly retained between the main washer 60 and the first washer 30. If the user desires to extend a conduit member 12 having a different outer diameter, the above process is simply repeated with a seal member 40, a main washer 60 and a first washer 30 having a center aperture the appropriate size to accommodate the conduit member 12.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A conduit sealing system for sealing an elongate object within a wall structure, comprising:
a coupler member having a first threaded portion, a second threaded portion and a tubular structure for receiving an elongate object;
a first retainer member threadably connected to said first threaded portion;
a seal member having a center aperture positionable within said coupler member; and
a second retainer member threadably connected to said second threaded portion.

2. The conduit sealing system of claim 1, wherein said seal member is comprised of a resilient material.

3. The conduit sealing system of claim 2, wherein said seal member is comprised of a rubber material.

4. The conduit sealing system of claim 1, wherein said center aperture has an inner diameter greater than an outer diameter of an elongate object.

5. The conduit sealing system of claim 1, wherein said coupler member has a first lumen portion adjacent to a first opening and a second lumen portion connected to said first lumen portion, wherein said second lumen portion has an inner diameter smaller than said first lumen portion.

6. The conduit sealing system of claim 5, wherein said first lumen portion is tapered adjacent to said second lumen portion.

7. The conduit sealing system of claim 1, wherein an outer diameter of said first threaded portion is less than an outer diameter of said second threaded portion forming an outer lip.

8. The conduit sealing system of claim 1, including a main washer positioned within said second retainer member for engaging said seal member.

9. The conduit sealing system of claim 8, wherein said main washer has a first portion and a second portion, wherein said first portion is larger than said second portion, and wherein said second retainer member has a first inner lip engagable with said first portion of said main washer.

10. The conduit sealing system of claim 1, wherein said coupler member includes first lumen portion adjacent to a first end of said coupler member, a second lumen portion connected to said first lumen portion, and a third lumen portion connected to said second lumen portion, wherein said second lumen portion has an inner diameter greater than an inner diameter of said third lumen portion forming an inner lip and wherein said first lumen portion has an inner diameter greater than an inner diameter of said second lumen portion.

11. A conduit sealing system for sealing an elongate object within a wall structure, comprising:
a coupler member having a first threaded portion, a second threaded portion having a greater outer diameter than said first threaded portion and a tubular structure for receiving an elongate object;
a first washer positionable within said coupler member adjacent an inner lip within said coupler member;
a second washer positioned about said first threaded portion adjacent said second threaded portion;
a first retainer member threadably connected to said first threaded portion;
a seal member having a center aperture positionable within said coupler member; and
a second retainer member threadably connected to said second threaded portion.

12. The conduit sealing system of claim 11, wherein said seal member is comprised of a resilient material.

13. The conduit sealing system of claim 12, wherein said seal member is comprised of a rubber material.

14. The conduit sealing system of claim 11, wherein said center aperture has an inner diameter greater than an outer diameter of an elongate object.

15. The conduit sealing system of claim 11, wherein said coupler member has a first lumen portion adjacent to a first opening and a second lumen portion connected to said first lumen portion, wherein said second lumen portion has an inner diameter smaller than said first lumen portion.

16. The conduit sealing system of claim 15, wherein said first lumen portion is tapered adjacent to said second lumen portion.

17. The conduit sealing system of claim 11, wherein an outer lip is formed between said first threaded portion and said second threaded portion.

18. The conduit sealing system of claim 11, including a main washer positioned within said second retainer member for engaging said seal member.

19. The conduit sealing system of claim 18, wherein said main washer has a first portion and a second portion, wherein said first portion is larger than said second portion, and wherein said second retainer member has a first inner lip engagable with said first portion of said main washer.

20. The conduit sealing system of claim 11, wherein said coupler member includes first lumen portion adjacent to a first end of said coupler member, a second lumen portion connected to said first lumen portion, and a third lumen portion connected to said second lumen portion, wherein said second lumen portion has an inner diameter greater than an inner diameter of said third lumen portion forming said inner lip and wherein said first lumen portion has an inner diameter greater than an inner diameter of said second lumen portion.
